(19) United States
(12) Patent Application Publication
(10) Pub. No.: US 2026/0260589 A1
(43) Pub. Date: Sep. 3, 2026

(54) Display Board

(71) Applicants: Chan Von O, Moscow (RU); Natalia Deryugina, Moscow (RU)

(72) Inventor: Nikolai Deriugin, Moscow (RU)

(21) Appl. No.: 19/155,236

(22) PCT Filed: Jan. 16, 2024
(86) PCT No.: PCT/RU2024/050008

§ 371 Date: Aug. 8, 2025

(30) Foreign Application Priority Data
Feb. 8, 2023 (RU) 2023102841

(51) Int. Cl. G09F 9/30; B32B 5/02; B32B 7/12; B32B 21/10; B32B 27/12

(52) U.S. Cl. CPC G09F 9/30; B32B 5/02; B32B 7/12; B32B 21/10; B32B 27/12; B32B 2250/03; B32B 2307/208; B32B 2307/762; B32B 2590/00

(57) ABSTRACT

The proposed invention relates to devices for presenting visual information and for advertising of various kinds and can be used in various fields: information, advertising, decoration, education, and the like. The object of the present invention is to create a reusable display board with a self-healing surface, to which informational materials of a general or specific nature and auxiliary elements can be securely fastened using pins, drawing pins, staples, tacks or other pointed fasteners which can be removed without leaving a trace, and also using magnets. The technical result is providing a display board to which materials can be securely fastened using a variety of different fastening elements and which remains in a fully serviceable condition even after repeated use.

### FIELD OF THE INVENTION

The proposed invention relates to devices for visual presentation and advertising of various types and may be used in information display, advertising, decorative, educational, and similar fields.

### BACKGROUND OF THE INVENTION

The closest known technical solution is U.S. Pat. No. 9,652,795, published on May 16, 2017, which discloses a bulletin board composed of a support layer in the form of a rigid cork sheet or wood fiber backing. Due to the elastic properties of cork, holes made by pushpins automatically close upon removal. However, with intensive use, the cork material deteriorates over time. Drawbacks of this bulletin board include the need for special paints to seal the front layer, the fragility and limited durability of the cork layer, and the inability to securely fasten relatively heavy informational and object materials and auxiliary elements, as well as to use fasteners such as heavy-duty staples, small nails, and/or magnets.

Furthermore, U.S. Pat. No. 1,494,583, published on May 20, 1924, discloses a bulletin board comprising a fire-resistant, non-deformable base, a cushion of elastic material firmly glued to it, and a border that wraps around the cushion inward.

The disadvantages of this board include an insufficiently resilient front surface that does not self-heal around punctures left after fasteners are removed. When securing relatively heavy informational or object materials and auxiliary elements, the top surface of the board may sag or crack at the point of penetration, causing fasteners to fall out and permanently damaging the appearance of the panel.

Additionally, in common practice, reusable display boards are made by stretching textile material over a rigid backing panel, with informational and exhibition materials secured using metallic single-shaft sewing pins (tailor's or dressmaker pins), so that the shaft of the pin lies parallel to the surface of the board, while the direction from the puncture point follows the vector of gravity. A disadvantage of such panels is that the puncture point in the textile layer often separates from the board surface by a distance significantly greater than the diameter of the pin shaft, allowing the pin to rotate freely around the puncture point and fall out easily.

### BRIEF SUMMARY OF THE INVENTION

The object of the present invention is to create a reusable display board with a self-healing surface, to which informational materials, object materials and auxiliary elements can be securely fastened, when necessary, using pins, pushpins, heavy-duty staples, tacks, or other pointed fasteners, leaving no visible trace upon removal, and also magnets.

The technical result is secure fastening using various fasteners while maintaining the panel's external appearance even after multiple uses.

Such a panel is particularly useful:
in educational institutions, community organizations, cultural institutions, etc., for hosting periodic low-budget exhibitions where it is necessary to repeatedly and securely attach informational (e.g., photographs, posters, text and graphic materials on various media) or object materials (e.g., small exhibits) to a vertical or inclined surface;
for posting interchangeable informational materials for various purposes (e.g., photographs, posters, text and graphic materials on various media) on stands in public spaces;
for the temporary placement of informational and illustrative materials during corporate events and meetings;
for displaying up-to-date information and reminders in offices and personal spaces.

This objective is achieved, and the technical result is realized, by providing a display board with a self-healing surface comprising at least three layers: a backing layer, an adhesive layer, and a front layer. The front layer is formed from a textile fabric subjected to reversible elastic deformation by stretching when affixed to the backing layer, while the adhesive layer consists of repositionable permanently tacky pressure-sensitive adhesive.

### BRIEF DESCRIPTION OF THE DRAWINGS

The essence of the invention is explained with reference to the drawings.

FIG. 1 illustrates the structural configuration of the display board.

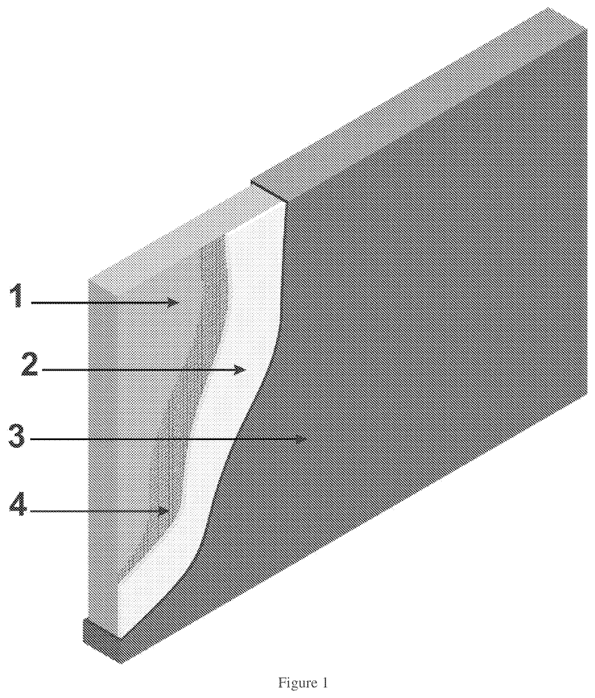

FIG. 2 shows the display board with fastening elements and attached informational and object materials.

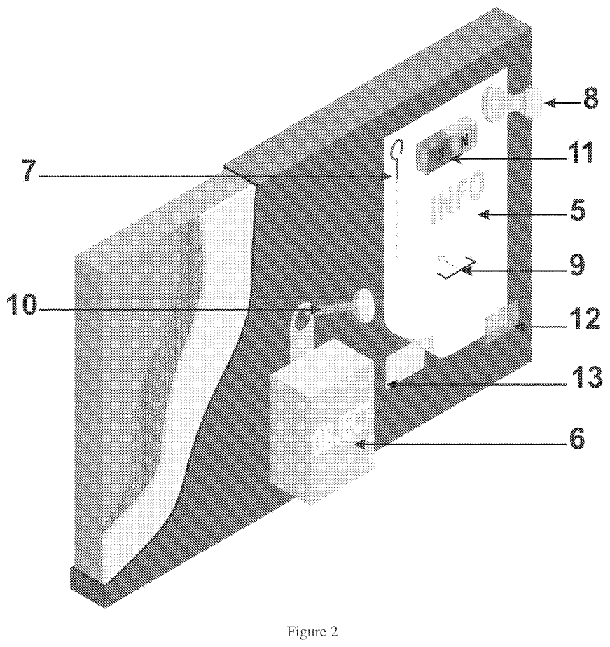

### DETAILED DESCRIPTION OF THE INVENTION

The backing layer 1, manufactured to the desired dimensions, is formed from one or more layers of sheet material. For added structural rigidity, these layers may be secured to a frame.

The adhesive layer 2 is created by applying an adequate layer of repositionable permanently tacky pressure-sensitive adhesive to each surface of the backing layer 1 that faces the front layer 3. A layer is also considered acceptable if its thickness is no more than 0.5 mm.

An additional layer 4 with ferromagnetic properties may be placed either between the backing layer 1 and adhesive layer 2 or integrated into the adhesive layer 2 itself.

The adhesive layer 2 may be applied in two stages, with a thin mesh possessing ferromagnetic properties embedded between the layers.

A textile fabric forming the front layer 3 is stretched over the adhesive layer 2 and secured—by any suitable means—to either the reverse side or the edges of the backing layer 1. The textile fabric must have a density of at least 200 gram per square meter, which ensures reliable retention of both informational and object materials. In addition, the textile fabric used must be low-pile, allowing adhesive tape or other self-adhesive materials (such as stickers) to adhere securely to its surface.

Any required image or graphic may also be applied to the textile fabric 3 using suitable techniques.

The completed panel can be mounted in a vertical, inclined, or horizontal orientation using any applicable known method, or otherwise employed in a conventional manner typical for display boards and information stands.

Informational materials 5 and/or object materials 6 can be affixed to the panel using any suitable known technique. Materials 5 and 6 may be secured to the display board using the following fastening elements:
metallic single-shaft sewing pins 7 (tailor's or dressmaker pins);
pushpins 8;
staples 9;
small nails or other pointed-shaft fasteners 10;
magnets 11 (provided the display board includes the ferromagnetic layer 4);
single-sided adhesive tape 12;
double-sided adhesive tape 13.

An example embodiment of the display board is as follows: The backing layer is made of FK sanded plywood, 10 mm thick, dimensions 1525×1525 mm, grade 2/2, per GOST 3916.1-2018, manufactured by Novy Resurs, LLC. The adhesive layer, 0.5 mm thick, is applied using Scotch PhotoMount spray adhesive manufactured by 3M Co. (Poland). The ferromagnetic intermediate layer is made from woven low-carbon steel wire mesh (black), specification 0.4×0.4 cm with 0.25 mm wire diameter, per GOST 3826-82, supplied by Novometall Trade, LLC. The front layer is made of gabardine LH G100-04/150, 230g/m² , smooth-dyed, solid-colored, double-sided, 100% polyester with a density of 200 gram per square meter, sourced from China.

The self-restoring display board is used as follows:

The user affixes the desired informational and exhibit materials to the board primarily using metallic single-shaft sewing pins (tailor's or dressmaker pins). The reliability of this fastening method is ensured by positioning the shaft of the pin within the adhesive layer so that it lies parallel to the surface of the board, while the direction from the puncture point in the front layer coincides with the vector of gravitational force. As a result, the pinhead is pressed against the surface of the board, holding the material in place due to the local elasticity of the front and adhesive layers, while the viscosity of the adhesive layer reliably keeps the shaft in its original position without rotating around the puncture point.

To remove the informational or exhibit materials, it is sufficient to extract the pins in a direction opposite to the force of gravity.

For mounting materials on a panel whose backing layer is made of plywood, wood, or other dense fibrous material capable of securely holding pointed fasteners with minimal effort, additional fastening options may include pushpins, staples, small nails, and other pointed-shaft fasteners. To remove these materials, the fasteners can be carefully extracted in a conventional manner.

For panels that incorporate a ferromagnetic layer between the backing and adhesive layers or as part of the adhesive layer, magnets may also be used for attachment.

If the backing layer is made from a ferromagnetic composite polymer sheet, materials can likewise be affixed using magnets or pins.

If the front layer is made of high-density, low-pile napless textile fabric, single-or double-sided adhesive tape (e.g., Scotch® tape) or self-adhesive materials (e.g., stickers) may also be employed.

After the materials are removed, punctures in the front layer gradually self-heal due to the local elasticity of the front and adhesive layers, or they can be immediately eliminated manually by gentle smoothing.

The display board according to the invention can also be made double-sided to comprise at least a front layer, an adhesive layer, a backing layer, an adhesive layer, and a front layer.

A board with such a self-healing front layer can be reused multiple times for displaying informational and exhibit content without affecting its external appearance.

The adhesive layer retains its properties throughout the board's operational life, as it is shielded from dust and external influences by the front layer.

For decorative or informational purposes, the front fabric layer may be made from textile materials in various colors, with patterns or printed images.

Accordingly, the proposed invention provides secure fastening with various fasteners while preserving the external appearance of the display board even after repeated use.

1. A display board comprising at least three layers-a backing layer, an adhesive layer, and a front layer—wherein the front layer is formed from a textile fabric subjected to reversible elastic deformation by stretching when affixed to the backing layer, and the adhesive layer is formed from repositionable permanently tacky pressure-sensitive adhesive.

2. (canceled) The display board of claim 1, characterized in that it is double-sided and comprises at least a front layer, an adhesive layer, a backing layer, an adhesive layer, and a front layer.

3. The display board of claim 1, wherein the backing layer is made of wood or another dense fibrous material.

4. The display board of claim 1, wherein the backing layer is made of a composite polymer sheet having ferromagnetic properties.

5. The display board of claim 1, wherein at least one additional layer with ferromagnetic properties is disposed either between the backing and adhesive layers or within the adhesive layer.
